(19) United States
(12) Patent Application Publication
(10) Pub. No.: US 2015/0373112 A1
(43) Pub. Date: Dec. 24, 2015

(54) HISTORY INFORMATION MANAGEMENT METHOD, AND HISTORY INFORMATION MANAGEMENT APPARATUS

(71) Applicant: FUJITSU LIMITED, Kawasaki-shi (JP)

(72) Inventor: Kazuaki NISHIMURA, Otaku (JP)

(73) Assignee: FUJITSU LIMITED, Kawasaki-shi (JP)

(21) Appl. No.: 14/730,779

(22) Filed: Jun. 4, 2015

(30) Foreign Application Priority Data
Jun. 23, 2014 (JP) 2014-127816

(51) Int. Cl. H04L 29/08; H04L 12/24; H04L 12/911

(52) U.S. Cl. CPC H04L 67/1097; H04L 47/823; H04L 41/5054; H04L 67/16

(57) ABSTRACT

A history information management method includes detecting competing access requests from among a plurality of access requests, utilizing history information that are generated by the plurality of access requests, each of the plurality of access requests being related to a plurality of data that are respectively mapped to a plurality of accounts; specifying an executed access request from among the detected competing access requests based on information relating to an executed access request; and specifying, for each of the plurality of accounts, part of the history information relating to an executed access to the data based on the specified access request and the history information.

### CROSS-REFERENCE TO RELATED APPLICATION

This application is based upon and claims the benefit of priority of the prior Japanese Patent Application No. 2014-127816, filed on Jun. 23, 2014, the entire contents of which are incorporated herein by reference.

### FIELD

The embodiments discussed herein are related to the management of history information.

### BACKGROUND

A network storage service in which a service provider provides a user with an information storage service or the like via a network has been proposed. The user of this service can store and obtain an object (data) in a storage (storage area) that the provider provides, via the network.

In an object storage service, a service provider provides a user with a storage, and charges the user for only a used storage capacity. The used storage capacity is a value that is calculated on the basis of the product of a used area and a use time. As an example, when a user uses an area of 1 GB for 1.0 hours (h), an amount of money that corresponds to 1 (GB)×1.0 (h)=1.0 (GB·h) is charged. As another example, when a user uses an area of 1 GB for 0.5 hours, an amount of money that corresponds to 1 (GB)×0.5 (h)=0.5 (GB·h) is charged.

In the object storage service, it is desirable for a used area and a use time to be accurately measured. As an example, when a user (hereinafter sometimes referred to as an “account”) uses storage of 1.5 (GB·h), increasing the used storage capacity to 2.0 (GB·h) for the convenience of the service is disadvantageous for the user. As another example, when a user uses storage of 1.5 (GB·h), reducing the used storage capacity to 1.0 (GB·h) for the convenience of the service is disadvantageous for the provider. As described above, it is undesirable for both the user and the provider that the used area and the use time are measured differently from actual conditions for the convenience of the service.

Meanwhile, as a technology relating to the management of a storage device, the following first and second technologies have been proposed.

In the first technology, a management system is connected to a storage device, which is a device that provides a logical volume, and a charging computer, which is a computer that determines an amount to be charged. The management system obtains an operation-related log, which is information relating to an operation that is requested for the storage device by a user and is normally completed, and stores the obtained operation-related log. The management system specifies, from among a plurality of operations that correspond to a plurality of operation-related logs, an invalid operation, which is an operation that satisfies a prescribed invalid operation condition, which is a condition that corresponds to an invalid operation. The management system performs summation in order to generate charging information, which is information including a summation result needed to determine an amount to be charged, by using operation-related logs other than an operation-related log relating to the specified invalid operation from among the plurality of operation-related logs, and transmits the charging information to the charging computer.

The second technology is a technology relating to a storage service that is performed in a storage device that manages a storage that receives access of information from a server. In the second technology, a server accesses a device file for which mapping to a storage has been set in the server so as to detect access to the storage that corresponds to the device file. In the second technology, a storage service charge to be charged to the server is then calculated on the basis of the detection of the access to the storage.

Technologies respectively described in the documents below are known.
Japanese Laid-open Patent Publication No. 2011-113306
Japanese Laid-open Patent Publication No. 2004-21796

### SUMMARY

According to an aspect of the embodiment, a history information management method includes detecting competing access requests from among a plurality of access requests, utilizing history information that are generated by the plurality of access requests, each of the plurality of access requests being related to a plurality of data that are respectively mapped to a plurality of accounts; specifying an executed access request from among the detected competing access requests based on information relating to an executed access request; and specifying, for each of the plurality of accounts, part of the history information relating to an executed access to the data based on the specified access request and the history information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a configuration of a storage system.

FIG. 2 illustrates an example of a configuration of an operation log.

FIG. 3 illustrates an example of a configuration of a summation server according to an embodiment.

FIG. 4 illustrates an example of a configuration of a storage system according to the embodiment.

FIG. 5 illustrates an example of a flowchart depicting details of a process performed by a notifying unit.

FIG. 6 illustrates an example of a flowchart depicting details of a log recording process performed by a summation server.

FIG. 7 illustrates an example of a flowchart depicting details of a summation process performed by a summation server.

FIG. 8 illustrates an example of a hardware configuration of a summation server or an internal server according to the embodiment.

### DESCRIPTION OF EMBODIMENTS

In a form in which a storage service is provided to a plurality of users, the plurality of users may simultaneously perform competing operations (access) on a storage. In a system based on eventual consistency, such as an object storage system, even when a plurality of operations are competing, exclusive control is not performed. In this case, when the plurality of operations are competing, one of the competing operations may be actually reflected in a state of data stored in the storage, but the other operations may fail to be reflected in the state of the data. Even if the first technology permits inconsistency and adapts to a circumstance where which of the competing operations has been performed is not known, as in the system based on eventual consistency, a correct execution result fails to be obtained.

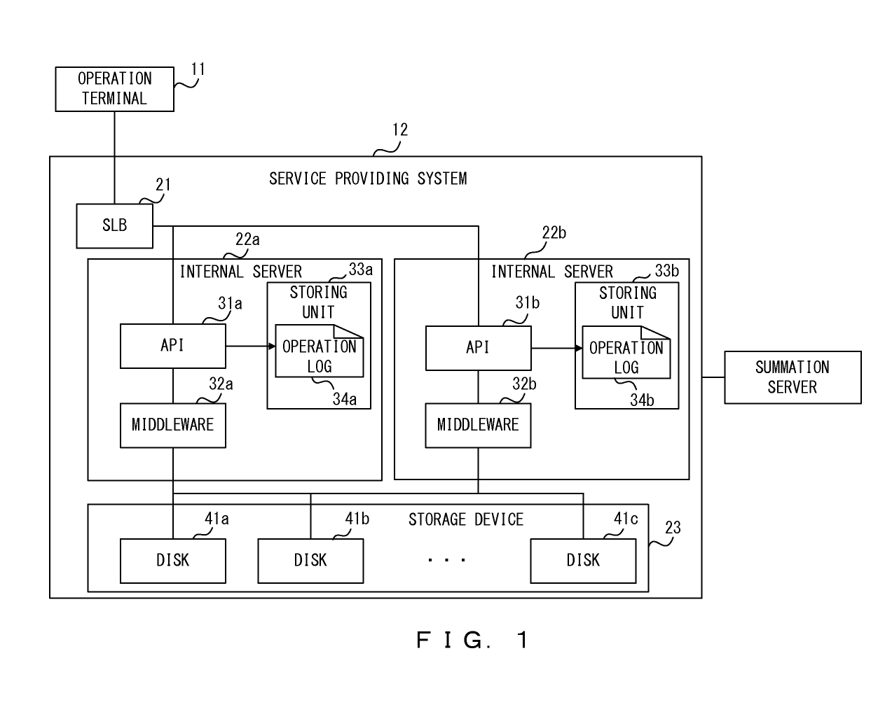

FIG. 1 illustrates an example of a configuration of a storage system. The storage system includes a service providing system 12 that provides an object storage service and a summation server that performs charging summation. The service providing system 12 is connected to an operation terminal 11 via a communication network.

The operation terminal 11 is an information processing device that receives an operation performed on the service providing system 12 from an operator. As an example, the operation terminal 11 receives, from the operator, an operation performed on the storage system, such as generation, deletion, or updating of an object, setting of an access right, or referencing of management information. The operation terminal 11 transmits an access request corresponding to the received operation to the service providing system 12. Then, the operation terminal 11 receives a response to the transmitted access request from the service providing system 12, and represents a response result to the operator via a prescribed output device. The operator may be the same as a user, who is an owner of the object, or may be different from the user. A plurality of operation terminals 11 may be provided.

The service providing system 12 includes a Server Load Balancer (SLB) 21, internal servers 22 (22a and 22b), and a storage device 23. The SLB 21, the internal servers 22, and the storage device 23 are connected via a bus or a communication network. Each of the internal servers 22 (22a and 22b) is connected to a summation server via a communication network or a bus.

The SLB 21 is an information processing device that distributes communication traffic for the operation terminal 11 to the internal servers 22a and 22b. The SLB 21 distributes loads on the internal servers 22 by distributing the communication traffic.

The internal server 22 includes an Application Programming Interface (API) 31 (31a or 31b), middleware 32 (32a or 32b), and a storing unit 33 (33a or 33b).

The API 31 is an interface that defines procedure, a data format, or the like for calling and using a function of the middleware 32, data managed by the middleware 32, or the like from another external program (software). The API 31 receives an access request for an object from the operation terminal 11 via the SLB 21. The API 31 outputs the received access request to the middleware 32, and stores, in the storing unit 33, an operation log 34 that records information relating to an operation indicated by the access request.

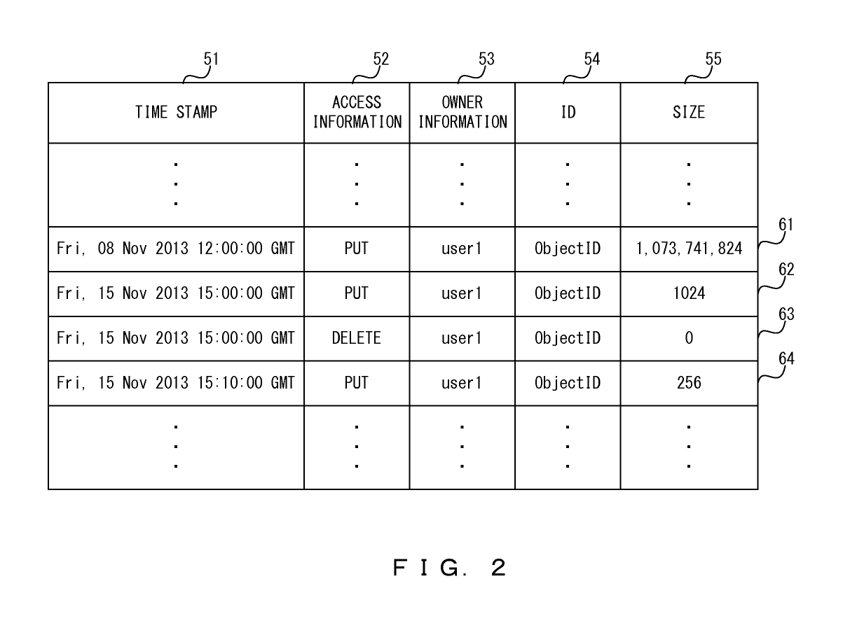

The storing unit 33 stores the operation log 34 (34a or 34b) that the API 31 has stored. FIG. 2 illustrates an example of a configuration of the operation log 34. The operation log 34 is information in which data items “time stamp” 51, “access information” 52, “owner information” 53, “ID” 54, and “size” 55 are associated. Records in the operation log 34 respectively correspond to access requests that the API 31 receives from the operation terminal 11. “Time stamp” 51 is information indicating the date and time when the API 31 receives an access request. “Access information” 52 is identification information for identifying the type of an operation indicated by the access request. “Owner information” 53 is identification information for identifying an owner of an object to be operated in reply to the access request. “ID” 54 is identification information for identifying the object to be operated in reply to the access request. “Size” 55 is information indicating the size of an object after the operation of the object to be operated in reply to the access request. Note that the owner of the object is a user (a person to be charged) of the object storage service.

In the example of FIG. 2, records 61, 62, 63, and 64 are recorded in the operation log 34. The record 62 indicates that the date and time when the API 31 receives a corresponding access request is “Fri, 8 Nov. 2013 12:00:00 GMT”, and that the type of an operation indicated by the corresponding access request is “PUT”. The record 62 further indicates that the owner of an object to be operated is “user1”, that identification information of the object to be operated is “ObjectID”, and that the size of the object after the operation is “1,073,741,824”. “PUT” as “access information” 52 in FIG. 2 indicates a command to upload an object, and “DELETE” indicates a command to delete an object.

The middleware 32 is software that virtualizes a disk 41 to be used, and that provides a function to enable a plurality of users to share and use one or a plurality of disks 41. The middleware 32 receives an access request from the API 31, and executes a command that corresponds to an operation indicated by the access request. As an example, upon receipt of a command indicated by an access request for the record 63, the middleware 32 deletes an object for which an owner is “user1” and an ID is “ObjectID” from the storage device 23.

The number of internal servers 22 is not limited to two, and may be one or plural, and the respective internal servers 22 may be made redundant. Further, the API 31 and the middleware 32 may be prescribed programs.

The storage device 23 includes one or more disks 41 (41a, 41b, and 41c), and stores an object that is mapped to a user (a person to be charged) in the disk 41. The object is accessed by the middleware 32 of the internal server 22 on the basis of the access request from the operation terminal 11. The object is data of a prescribed unit, such as a directory or a file. Information indicating mapping of the object and the user is stored in, for example, attribute information (metadata) that is given to each of the objects. The objects may be distributed and arranged in a plurality of storage devices 23 or a plurality of disks 41, or may be multiplexed and stored. In FIG. 1, one storage device 23 is illustrated, but a plurality of storage devices 23 may be provided. The disk 41 may be a prescribed storage such as a semiconductor memory. The information indicating mapping of the object and the user is, for example, information in which “owner information” 53 and “ID” 54 in FIG. 2 are mapped.

A summation server that performs charging summation is connected to the service providing system 12 described above. There are several methods for performing charging summation by using the summation server. In order to explain effects of the embodiment, two comparative examples are first described. Then, a configuration of the embodiment is described, and the effects of the embodiment are described while comparing the embodiment with the comparative examples.

A method of summation in comparative example 1 is first described. A summation server in comparative example 1 calculates a used storage capacity for respective users by periodically inquiring about (obtaining) a state of an object for the respective users of the service providing system 12.

In comparative example 1, the middleware 32 maps in advance information relating to the object to information relating to the user, and stores information obtained by the mapping as mapping information in a prescribed storage area. The information relating to the object is, for example, information indicating identification information of the object (object ID) or the size of the object. The information relating to the user is, for example, identification information of the user (owner information). Mapping of the information relating to the object and the information relating to the user is performed at a prescribed timing such as uploading of the object (generation of a new object).

The summation server inquires about the state of the object of the middleware 32 of the service providing system 12 in which the mapping as described above has been performed, individually for the respective users at every fixed time.

Upon receipt of the inquiry, the middleware 32 confirms the state of the object for the respective users, and returns a confirmation result as state information to the summation server. When confirming the state of the object, the middleware 32 first obtains, for example, list information of the objects for the respective users. The list information is obtained on the basis of the mapping information that has been stored in the prescribed storage area. Then, the middleware 32 accesses the storage device 23 for the objects listed in the obtained list information, and obtains the sizes of the respective objects. The middleware 32 transmits the obtained sizes of the respective objects to the summation server.

The summation server receives the state information from the middleware 32, and sums the sizes of the objects for the respective users that are included in the state information. The summation server sets a summed value to be a used storage capacity for the respective users.

In a system in which, in the network storage service, one disk is assigned to each of the users, the used storage capacity for each of the users can be measured by referencing statistical information of the disk. However, in a system using a cloud technology, for example, a disk is virtualized, and a specified disk is shared and used by a plurality of users. In this case, the size of an object for the respective users is measured via the middleware 32 that provides a mechanism in which the specified disk is shared by the plurality of users.

In the system of comparative example 1, when inquiries are made from the summation server with high frequency, a load on the middleware 32 for processing the inquiries increases.

The middleware 32, which receives the inquiries, accesses the respective objects for the respective users, and obtains the sizes of the respective objects, and therefore the load on the middleware 32 is large.

Inquiries and responses increase communication traffic between the storage device 23 and the internal server 22. When the processing load and the communication traffic increase as described above, the performance of uploading or downloading of an object, which is a service to a user, may be influenced.

On the other hand, when an inquiry frequency is reduced in order to reduce the inquiry load or traffic amount, a calculation result for a used storage capacity becomes inaccurate. It is because the case described below, for example, occurs that a reduction in the inquiry frequency results in an inaccurate calculation result for the used storage capacity.

In comparative example 1, as an example, in a case in which an interval between inquiries is T hours, when uploading and deletion of an object are performed during T hours, a calculated used storage capacity is 0. As an example, in the system of comparative example 1 in which inquiries are made at one-hour intervals, a case in which the following operations are performed is considered.
(1) 0:00 A summation server makes an inquiry.
(2) 0:20 A user uploads an object of 1 GB.
(3) 0:50 The user deletes the object of 1 GB.
(4) 1:00 The summation server makes an inquiry.
   In this case, a result value of the used storage capacity is 1 (GB)×0.5 (h)=0.5 (GB·h). However, the summation server in comparative example 1 calculates the used storage capacity to be 0 (GB)×0 (h)=0.0 (GB·h). This is because the object of 1 GB that has been generated in (2) and has been deleted in (3) does not exist in (1) and (4).

As described above, in comparative example 1, when a prescribed access is performed between two inquiries, the prescribed access sometimes fails to be accurately grasped. This is because a change in a state of the object after the first inquiry and before the next inquiry is not considered in comparative example 1. As described above, in the system of comparative example 1, when the inquiry frequency is reduced, access results fail to be obtained, and the calculation result for the used storage capacity becomes inaccurate.

A summation method in comparative example 2 is described next. A summation server in comparative example 2 collects operation logs 34 from the service providing system 12 at a stage of a process of summing a charged amount for respective users. A timing at which a summing process is performed has no relevance to a timing at which the operation log 34 is recorded. The summation server in comparative example 2 analyzes the collected operation logs 34 and traces “used area” and “use time” for the respective users, and calculates a used storage capacity.

A case is considered in which comparative example 2 is applied to a system in which content of the operation log 34 may be different from content of an access request that is actually reflected in an object when a plurality of access requests compete. Examples of this system include a system in which, when a plurality of access requests compete, only one access request (for example, the last executed access request) from among the competing access requests is reflected in a state of the object, such as a system based on eventual consistency, and other systems. In this case, the summation server in comparative example 2 fails to trace an access request that has been actually executed by the middleware 32 when competition occurs. Here, a case in which a plurality of access requests compete is specifically, for example, a case in which a providing system receives a plurality of access requests from a user's terminal at the same time or during a prescribed time period, or other cases.

A case is considered in which the operation log 34 as illustrated in FIG. 2 is recorded in, for example, the system based on the eventual consistency. In FIG. 2, the record 62 and the record 63 have the same value of “ID” 54, “ObjectID”, the same value of “owner information” 53, “user1”, and the same value of “time stamp” 51, “Fri, 15 Nov. 2013 15:00:00 GMT”. Values of “access information” 52 in the record 62 and the record 63 are respectively “PUT” and “DELETE”. These indicate that two different access requests for the same object are received by the API 31 at the same time. Namely, the access requests “PUT” and “DELETE” that respectively correspond to the record 62 and the record 63 have a relationship of competing with each other. In addition, the record 64 indicates that the access “PUT” has been performed to an object that is the same as the objects to be accessed in the records 62 and 63, that is, an object for which “ID” 54 is “ObjectID” and “owner information” 53 is “user1”.

In the example of FIG. 2, the summation server in comparative example 2 fails to determine from the operation log 34 which access request of the competing records 62 and 63 has actually been executed.

In view of the foregoing, a method is also considered in which the summation server in comparative example 2 determines whether competition has occurred on the basis of the operation log 34 at a summation stage, and inquires of the middleware 32 about the state of the object when the summation server determines that the competition has occurred. However, also in this case, when another access is performed to an object to which competing accesses have been performed after the competing accesses before the summation, the summation server fails to determine which of the competing access requests has been executed.

In the example of FIG. 2, for example, the record 64 indicates that the access “PUT” is performed to an object to which competing access requests have been issued, that is, an object for which “ID” 54 is “ObjectID” and “owner information” 53 is “user1”. Accordingly, no matter which access request of the record 62 and the record 63 has been executed, the object for which “ID” 54 is “ObjectID” and “owner information” 53 is “user1” exists as an object having a size of “256” at the time of summation. Accordingly, even if the summation server in comparative example 2 inquires of the middleware 32 about the state of the object at the time of summation, the summation server fails to determine which access request of the record 62 and the record 63 has been executed. Therefore, the summation server in comparative example 2, for example, performs determination in a summation process, assuming that “DELETE” in the record 63 has been executed, in order not to unjustly charge a user.

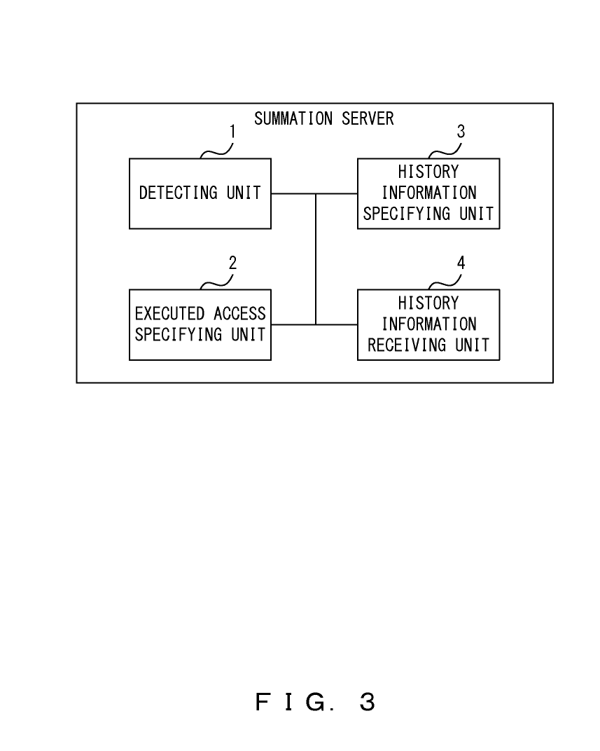

FIG. 3 illustrates an example of a configuration of a summation server according to the embodiment. In FIG. 3, the summation server includes a detecting unit 1, an executed access specifying unit 2, a history information specifying unit 3, and a history information receiving unit 4.

The detecting unit 1 detects competing access requests from among a plurality of access requests, utilizing history information that are generated by the plurality of access requests, each of the plurality of access requests being related to a plurality of data that are respectively mapped to a plurality of accounts.

The executed access specifying unit 2 specifies an executed access request from among the detected competing access requests based on information relating to an executed access request.

The history information specifying unit 3 specifies, for each of the plurality of accounts, part of the history information relating to an executed access to the data based on the specified access request and the history information.

The information relating to the executed access request is information indicating the size of data immediately after access is performed in reply to the executed access request.

The history information receiving unit 4 sequentially receives the history information that is notified from a receiver that receives the access request when the receiver receives the access request. Upon receipt of the pieces of history information, the detecting unit 1 detects competing access requests from among the plurality of access requests, utilizing the history information. When the competing accesses are detected, the executed access specifying unit 2 obtains the information relating to the executed access request, and specifies the executed access request from among the competing access requests on the basis of the obtained information.

The summation server according to the embodiment can obtain an access result for data that receives access requests from a plurality of accounts for each of the plurality of accounts at a low load.

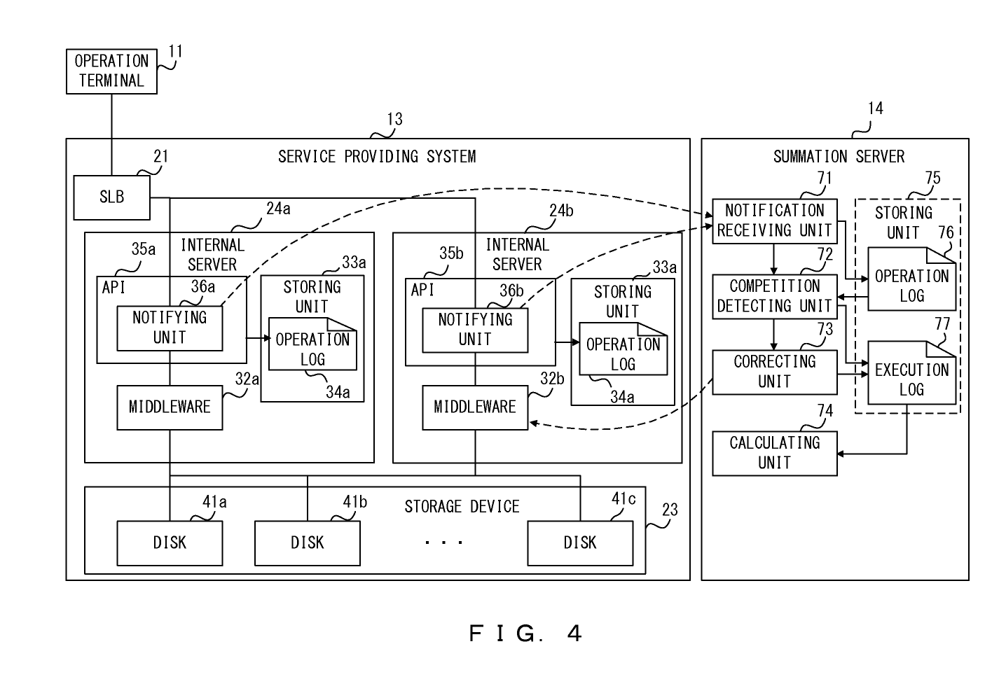

FIG. 4 illustrates an example of a configuration of a storage system according to the embodiment. The storage system includes a service providing system 13 and a summation server 14 that performs charging summation. The service providing system 13 is connected to an operation terminal 11 via a communication network. The service providing system 13 and the summation server 14 are connected via the communication network or a bus.

The operation terminal 11 is similar to the operation terminal described with reference to FIG. 1.

The service providing system 13 includes an SLB 21, internal servers 24 (24a and 24b), and a storage device 23. The SLB 21, the internal servers 24, and the storage device 23 are connected via a bus or a communication network. Each of the internal servers 24 (24a and 24b) is connected to the summation server 14 via a communication network or a bus. In FIG. 4, the number of the internal servers 24 and the number of the storage devices 23 may be a specified number that is greater than or equal to 1.

The SLB 21 and the storage device 23 are similar to those described with reference to FIG. 1.

The internal server 24 includes an API 35 (35a or 35b), middleware 32 (32a or 32b), and a storing unit 33 (33a or 33b).

The API 35 is an interface that defines procedure, a data format, or the like to call a function of the middleware 32, data managed by the middleware 32, or the like from another external program (software) and to use it. The API 35 receives an access request for an object from the operation terminal 11 via the SLB 21. Then, the API 35 outputs the received access request to the middleware 32, and stores an operation log 34 (34a or 34b) that records information relating to the access request, in the storing unit 33.

The API 35 includes a notifying unit 36 (36a or 36b). When the API 35 receives an access request, the notifying unit 36 generates record information of the operation log 34 that corresponds to the received access request, and notifies the summation server 14 of the generated record information. The notifying unit 36 issues notification to the summation server 14 every time the API 35 receives an access request.

The middleware 32 and the storing unit 33 are similar to those described with reference to FIG. 1. The operation log 34 is similar to that described with reference to FIG. 2.

The number of internal servers 24 is not limited to two, and may be one or plural, and the respective internal servers 24 may be made redundant. The API 35 and the middleware 32 may be prescribed programs.

The summation server 14 performs a log recording process and a summation process. The log recording process is a process of generating an execution log 77 generated by extracting a log of an access that is actually executed by the middleware 32 from the operation log 34. The summation process is a process of calculating a used storage capacity for respective users on the basis of the execution log 77, and of performing charging summation for the respective users.

In the log recording process, the summation server 14 first receives the operation log, and detects competing accesses on the basis of the received operation log. The summation server 14 then obtains information relating to an executed access request when the summation server 14 detects the competing accesses. The summation server 14 extracts the executed access request from among the competing access requests from the operation log on the basis of the obtained information relating to the executed access request, and records a log after the extraction as the execution log 77.

The summation server 14 includes a notification receiving unit 71, a competition detecting unit 72, a correcting unit 73, a calculating unit 74, and a storing unit 75. The notification receiving unit 71 is an example of the history information receiving unit 4. The competition detecting unit 72 is an example of the detecting unit 1. The correcting unit 73 is an example of the executed access specifying unit 2 and the history information specifying unit 3.

The notification receiving unit 71 receives record information of the operation log from the notifying unit 36. The notification receiving unit 71 then outputs the received record information of the operation log to the competition detecting unit 72, and records the record information in the operation log 76.

When the record information is input from the notification receiving unit 71, the competition detecting unit 72 references the operation log 76, and detects competing access requests. Namely, the competition detecting unit 72 determines whether an access request indicated by the record information input from the notification receiving unit 71 (hereinafter referred to as “target record information”) is competing with another access request.

Specifically, the competition detecting unit 72 refers to the operation log 76, and determines whether a record for which “time stamp” 51 matches the target record information (hereinafter referred to as “competing record information”) exists. When it is determined that the competing record information exists, the competition detecting unit 72 extracts the competing record information, and determines that an access request indicated by the target record information is competing with another access request. Then, the competition detecting unit 72 outputs the target record information and the competing record information to the correcting unit 73.

When it is determined that a record for which “time stamp” 51 matches the target record information does not exist, the competition detecting unit 72 determines that the access request indicated by the target record information is not competing with another access request, and records the target record information in the execution log 77.

When the target record information and the competing record information are input from the competition detecting unit 72, the correcting unit 73 inquires of the middleware 32 about a state of an object indicated by “owner information” 53 and “ID” 54 of the target record information (hereinafter referred to as a “competing object”).

Upon receipt of the inquiry, the middleware 32 confirms a state of the competing object, and returns a confirmation result as state information to the correcting unit 73. When confirming the state of the object, specifically, for example, the middleware 32 accesses the storage device 23 or the competing object, and obtains information indicating the size of the competing object. As an example, the middleware 32 may obtain the size by directly referring to the competing object by using a command or the like. The middleware 32 then transmits the obtained information indicating the size of the competing object to the summation server 14. Here, the state information is information relating to an executed access request, and the state information is not limited to the information indicating the size of the competing object as long as it is information that can specify an executed access request from among competing access requests on the basis of the state information.

Upon receipt of the state information from the middleware 32 as a response to the inquiry, the correcting unit 73 specifies an actually executed access request from among access requests that correspond to the competing record information and the target record information on the basis of the received state information.

Specifically, as an example, when the state information is the information indicating the size of the competing object, the correcting unit 73 compares, for the respective competing access requests, the size of an object after execution in a case in which the respective access requests are assumed to be executed with the size indicated by the state information. The correcting unit 73 then specifies an access request for which a comparison result indicates coincidence to be an executed access request. As an example, a case is considered in which an executed access request is specified of competing access requests, the record 62 and the record 63 of FIG. 2. In this case, when the size of an object indicated by the state information is “1024”, the correcting unit 73 specifies that the record 62 is an executed access request because the size of an object when the access request, the record 62, is assumed to be executed is “1024”.

Then, the correcting unit 73 records record information corresponding to the executed access request of the competing record information and the target record information in the execution log 77. The correcting unit 73 also deletes record information corresponding to a non-executed access request from the execution log 77 when the record information corresponding to the non-executed access request exists in the execution log 77.

The calculating unit 74 refers to the execution log 77, and calculates a used area and a use time for respective users. In the execution log 77, entry information of the operation log 76 that is actually executed on an object has been recorded. As an example, when the used area and the use time are calculated for a prescribed person to be charged, the calculating unit 74 first extracts an entry for which “owner information” 53 of the execution log 77 indicates the person to be charged. The calculating unit 74 then specifies the date and time when the sizes of respective objects for the person to be charged have been changed, on the basis of the extracted entry. Because the used area of the person to be charged is equal to the sum of the sizes of the respective objects for the person to be charged, the calculating unit 74 can calculate the used area and the use time of the person to be charged on the basis of the date and time when the sizes of the respective objects for the person to be charged have been changed. The calculating unit 74 calculates the product of the used area and the use time, and calculates a charged amount of money for the person to be charged on the basis of the calculated value.

The storing unit 75 stores the operation log 76 and the execution log 77. In the operation log 76, pieces of information that have the same contents as those of the operation logs 34a and 34b are integrated and recorded. A plurality of operation logs 76 may be stored so as to respectively correspond to the operation logs 34a and 34b. The execution log 77 is information in which a record that corresponds to an access request that the competition detecting unit 72 and the correcting unit 73 determine to have been executed from among records recorded in the operation log 76 has been recorded. Therefore, the execution log 77 includes the data items “time stamp” 51, “access information” 52, “owner information” 53, “ID” 54, and “size” 55, similarly to the operation log 76 (34). It is assumed that an access request for which competition is not detected is determined to be an executed access request.

The summation server 14 according to the embodiment receives an operation log from the notifying unit 36 every time the API 35 receives an access request from the operation terminal 11. The summation server 14 then detects competition on the basis of the received operation log, and inquires about a state of a competing object of the middleware when the summation server 14 detects the competition. Therefore, a frequency of inquiries to the middleware 32 can be reduced in the embodiment, compared with comparative example 1. As a result, in the embodiment, a load on the middleware 32 can be reduced, and communication traffic between the storage device 23 and the internal server 24 can be reduced.

In addition, in the summation server 14 according to the embodiment, the competition detecting unit 72 performs a process of detecting competition at a timing immediately after the notification receiving unit 71 receives target record information. This allows a time period from an actual occurrence of competition of access requests to the detection of the competition to be reduced. Further, the summation server 14 inquires about a state of a competing object at a timing immediately after the detection of the competition so as to reduce a time period from an occurrence of the competition to the inquiry. As a result, the summation server 14 can obtain a more accurate execution state of an object than the execution state in comparative example 1 or comparative example 2. This is because a probability of another access to the competing object being performed after the competition occurs and before an inquiry about the competing object is made is reduced.

The notification receiving unit 71 may obtain the record information of the operation log 34 from the API 35 at prescribed time intervals. A load on the internal server 24 is smaller in a process of obtaining the operation log 34 than in an inquiry about the state of the competing object, and therefore the notification receiving unit 71 can obtain the operation log 34 with a high frequency. In this case, compared with comparative example 1, a load on the middleware (internal server 24) and communication traffic between the storage device 23 and the internal server 24 can be reduced. An access result can be specified in the embodiment more accurately than in comparative example 2.

In addition, the summation server 14 according to the embodiment can specify an access result without using a log that is output within the middleware 32 when calculating a used storage capacity. The middleware 32 is considered to be frequently upgraded, and a log in the middleware 32 may become incompatible in format when the middleware 32 is upgraded. Such non-compatibility causes services to not be provided. On the other hand, in the summation server 14 according to the embodiment that does not use the log in the middleware as described above, summation of the used storage capacity is independent of non-compatibility of the middleware 32, and therefore services can be stably provided.

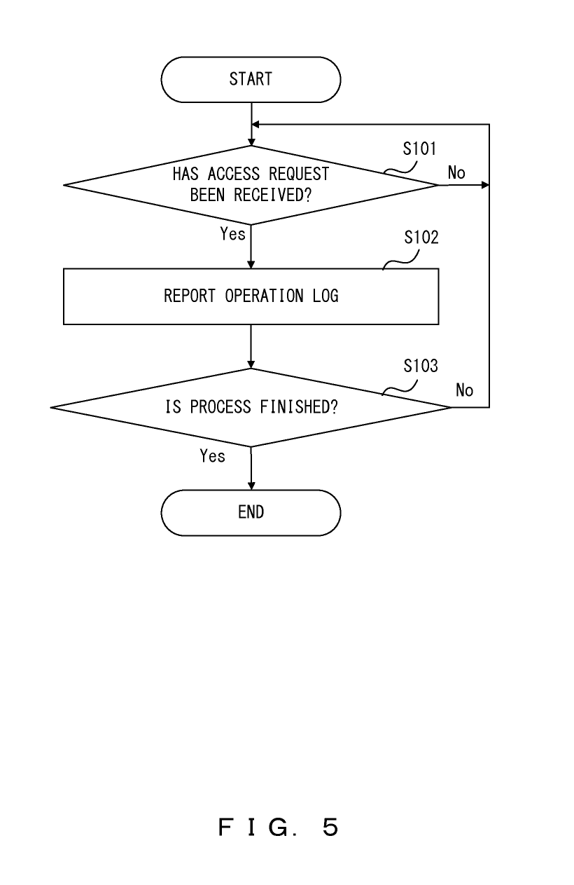

An operational flow of the notifying unit 36 is described next. FIG. 5 illustrates an example of a flowchart depicting details of a process performed by the notifying unit 36.

In FIG. 5, the notifying unit 36 first determines whether an access request has been received from the operation terminal 11 (S101). When the notifying unit 36 determines that an access request has not been received from the operation terminal 11 (“No” in S101), the notifying unit 36 transits the process to S101 again.

When the notifying unit 36 determines that an access request has been received for the operation terminal 11 (“Yes” in S101), the notifying unit 36 notifies the summation server 14 of an operation log (S102). Namely, the notifying unit 36 generates record information of the operation log that corresponds to the received access request, and notifies the notification receiving unit 71 of the generated record information. The notifying unit 36 then determines whether a series of processes are finished (S103), and when the notifying unit 36 determines to continue the processes (“No” in S103), the notifying unit 36 transits the process to S101. When the notifying unit 36 determines to finish the processes (“Yes” in S103), the notifying unit 36 finishes the processes.

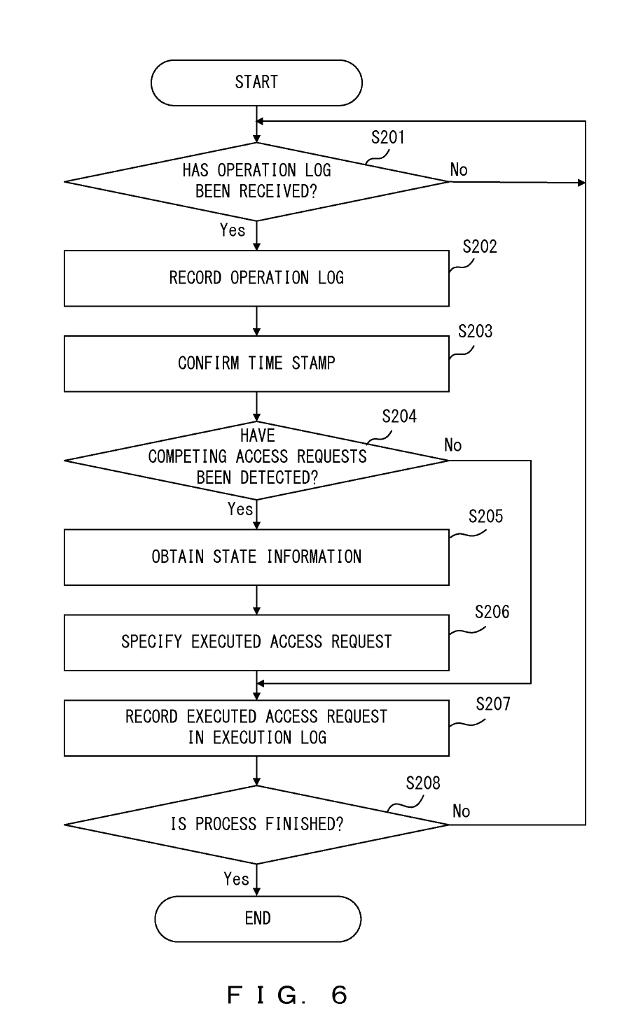

An operational flow of a log recording process performed by the summation server 14 is described next. FIG. 6 illustrates an example of a flowchart depicting details of the log recording process performed by the summation server.

In FIG. 6, the notification receiving unit 71 first determines whether a notification including target record information of the operation log has been received from the notifying unit 36 (S201). When the notification receiving unit 71 determines that a notification has not been received (“No” in S201), the process returns to S201.

When the notification receiving unit 71 determines that a notification has been received (“Yes” in S201), the notification receiving unit 71 outputs the received target record information to the competition detecting unit 72, and records the received target record information in the operation log 76 (S202).

The competition detecting unit 72 then compares a time stamp of the target record information with a time stamp of each piece of record information in the operation log 76 (S203).

As a result of the comparison of time stamps, the competition detecting unit 72 detects competing record information for which a value of “time stamp” 51 matches that of the target record information from among respective records in the operation log 76 (S204). When the competition detecting unit 72 does not detect any competing records (“No” in S204), the competition detecting unit 72 specifies the target record information to be record information that corresponds to an executed access request, and transits the process to S207.

When the competition detecting unit 72 detects a competing record (“Yes” in S204), the competition detecting unit 72 outputs the target record information and the competing record information to the correcting unit 73. The correcting unit 73 inquires of the middleware 32 about a state of the competing object indicated by “owner information” 53 and “ID” 54 of the target record information. The correcting unit 73 then receives state information as a response to the inquiry from the middleware 32 (S205).

The correcting unit 73 then specifies an actually executed access request from among access requests of the competing record information and the target record information on the basis of the received state information (S206).

The correcting unit 73 records the record information of the executed access request in the execution log 77 (S207). Here, the executed access request is the access request specified in S206 when a competing access request is detected in S204, and the executed access request is the access request of the target record information when a competing access request is not detected in S204.

The correcting unit 73 determines whether the log recording process is finished (S208), and when the correcting unit 73 determines to continue the process (“No” in S208), the correcting unit 73 transits the process to S201. When the correcting unit 73 determines to finish the process (“Yes” in S208), the correcting unit 73 finishes the log recording process.

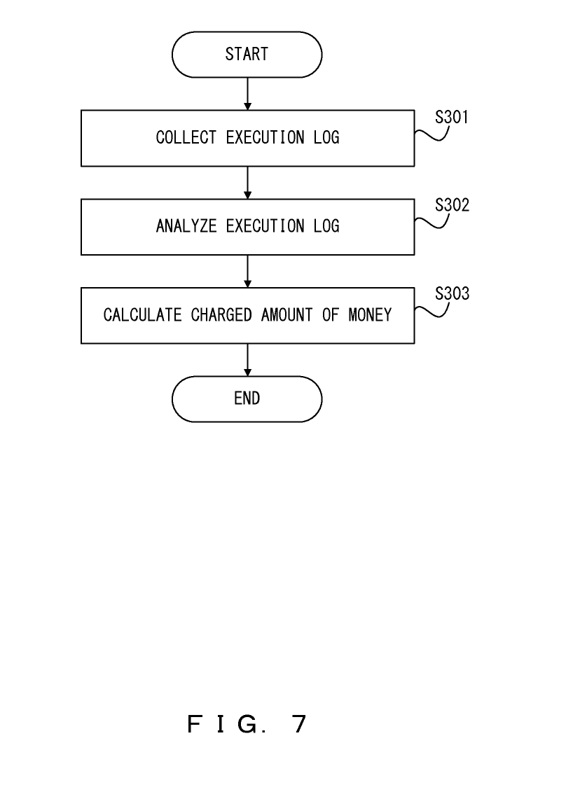

An operational flow of a summation process performed by the summation server 14 is described next. FIG. 7 illustrates an example of a flowchart depicting details of the summation process performed by the summation server. FIG. 7 illustrates a flow of a process of summing a charged amount of money for a specified account to be charged (hereinafter referred to as an “account to be charged”) from among a plurality of accounts.

In FIG. 7, the calculating unit 74 first refers to the execution log 77 (S301). The calculating unit 74 then analyzes the execution log 77, and extracts entry information that corresponds to an account to be charged from the execution log 77 (S302). The calculating unit 74 calculates the product of a used area and a use time of the account to be charged on the basis of the extracted entry information, and calculates a charged amount of money for respective users on the basis of the calculated value (S303). Then, the process is finished.

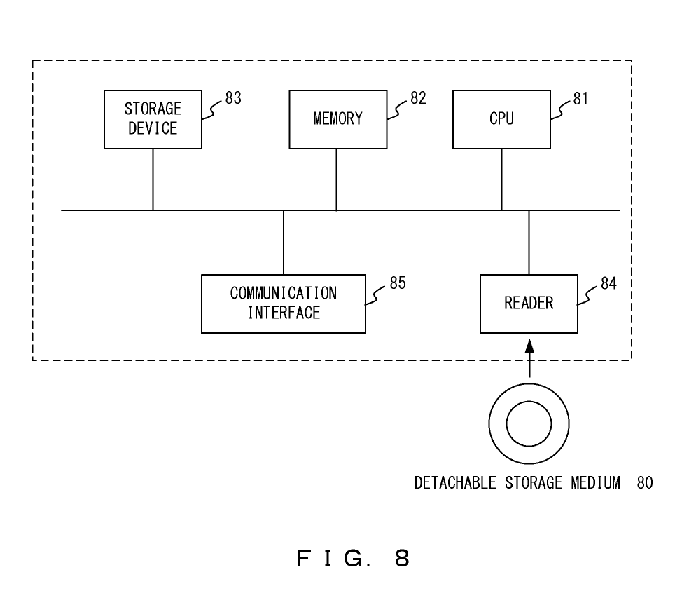

A hardware configuration of the summation server 14 or the internal server 24 is described next. FIG. 8 illustrates an example of a hardware configuration of a summation server or an internal server according to the embodiment.

In FIG. 8, the summation server 14 or the internal server 24 includes a Central Processing Unit (CPU) 81, a memory 82, a storage device 83, a reader 84, and a communication interface 85. The CPU 81, the memory 82, the storage device 83, the reader 84, and the communication interface 85 are connected via a bus.

In the summation server 14, the CPU 81 provides a portion of or all of the functions of the notification receiving unit 71, the competition detecting unit 72, the correcting unit 73, and the calculating unit 74 by executing a program that describes procedures of the flowcharts above by using the memory 82. In the internal server 24, the CPU 81 provides a portion of or all of the functions of the API 35, the middleware 32, and the notifying unit 36.

The memory 82 is, for example, a semiconductor memory, and is configured so as to include a Random Access Memory (RAM) area and a Read Only Memory (ROM) area. The storage device 83 is, for example, a hard disk. The storage device 83 may be a semiconductor memory such as a flash memory. The storage device 83 may be an external recording device. In the summation server 14, the memory 82 or the storage device 83 provides a portion of or the entirety of a function of the storing unit 75. In the internal server 24, the memory 82 or the storage device 83 provides a portion of or the entirety of a function of the storing unit 33.

The reader 84 accesses a detachable storage medium 80 in accordance with an instruction of the CPU 81. The detachable storage medium 80 is realized by, for example, a semiconductor device (e.g., a USB memory 82), a medium that information is input to or output from by a magnetic action (e.g., a magnetic disk), a medium that information is input to or output from by an optical action (e.g., a CD-ROM or a DVD), or the like. The reader 84 may be provided outside the summation server 14 or the internal server 24.

The communication interface 85 is an interface that performs communication via a network or a bus in accordance with an instruction of the CPU 81. In the summation server 14, the communication interface 85 communicates with the internal server 24. In the internal server 24, the communication interface 85 communicates with the operation terminal 11, the summation server 14, and the storage device 23.

A program according to the embodiment is provided to the summation server 14 or the internal server 24 in the following forms, for example.

(1) The program has been installed on the storage device 83.
(2) The program is provided by the detachable storage medium 80.
(3) The program is provided from a program server (not illustrated) via the communication interface 85.

The internal server 24 is connected to one or more storage devices 23 via a bus or a communication network. The storage device 23 is, for example, a hard disk or a disk array device. The storage device 83 may be a semiconductor memory such as a flash memory. The storage device 83 provides a portion of or the entirety of a function of the storage device 23.

Further, a portion of the summation server 14 or the internal server 24 according to the embodiment may be realized by hardware. Alternatively, the summation server 14 or the internal server 24 according to the embodiment may be realized by a combination of software and hardware.

In the summation server 14, one or more virtual servers may be operated, and the respective virtual servers may provide a portion of or a prescribed combination of functions of the notification receiving unit 71, the competition detecting unit 72, the correcting unit 73, and the calculating unit 74. In the internal server 24, one or more virtual servers may be operated, and the respective virtual servers may provide a portion of or a prescribed combination of functions of the API 35, the middleware 32, and the notifying unit 36. Further, the internal server 24 may be configured so as to realize a function of the storing unit 33 by using a virtual disk.

The embodiments discussed herein are not limited to the embodiment described above, and can have various configurations or embodiments without departing from the spirit of the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A history information management method comprising:
detecting competing access requests from among a plurality of access requests, utilizing history information that are generated by the plurality of access requests, each of the plurality of access requests being related to a plurality of data that are respectively mapped to a plurality of accounts;
specifying an executed access request from among the detected competing access requests based on information relating to an executed access request; and
specifying, for each of the plurality of accounts, part of the history information relating to an executed access to the data based on the specified access request and the history information.

2. The history information management method according to claim 1, wherein
the information relating to an executed access request is information that indicates a size of the data immediately after an access is performed in reply to the executed access request.

3. The history information management method according to claim 1, further comprising:
sequentially receiving the history information that is notified from a receiver that receives the access request when the receiver receives the access request, wherein
the detecting detects competing access requests from among the plurality of access requests, utilizing the history information, upon receipt of the history information; and
the specifying the executed access request includes obtaining the information relating to the executed access request, and specifying the executed access request from among the competing access requests on the basis of the obtained information, when the competing accesses are detected.

4. A history information management apparatus comprising:
a processor which executes a process including:
detecting competing access requests from among a plurality of access requests, utilizing history information that are generated by the plurality of access requests, each of the plurality of access requests being related to a plurality of data that are respectively mapped to a plurality of accounts;
specifying an executed access request from among the detected competing access requests based on information relating to an executed access request; and
specifying, for each of the plurality of accounts, part of the history information relating to an executed access to the data based on the specified access request and the history information.

5. A non-transitory computer-readable recording medium having stored therein a history information management program that causes a computer to execute a process comprising:
detecting competing access requests from among a plurality of access requests, utilizing history information that are generated by the plurality of access requests, each of the plurality of access requests being related to a plurality of data that are respectively mapped to a plurality of accounts;
specifying an executed access request from among the detected competing access requests based on information relating to an executed access request; and
specifying, for each of the plurality of accounts, part of the history information relating to an executed access to the data based on the specified access request and the history information.
